(19) United States
(12) Patent Application Publication
(10) Pub. No.: US 2017/0249224 A1
(43) Pub. Date: Aug. 31, 2017

(54) SEMICONDUCTOR DEVICE

(71) Applicant: Renesas Electronics Corporation, Tokyo (JP)

(72) Inventors: Iwao SUZUKI, Tokyo (JP); Naoki KATO, Tokyo (JP)

(21) Appl. No.: 15/372,709

(22) Filed: Dec. 8, 2016

(30) Foreign Application Priority Data
Feb. 25, 2016 (JP) 2016-034456

(51) Int. Cl. G06F 11/22; G06F 11/27

(52) U.S. Cl. CPC G06F 11/2215; G06F 11/27

(57) ABSTRACT

A semiconductor device that can be caused to easily generate an internal pseudo error is provided. Error detection circuits detect an error occurring in the semiconductor device and output error signals that are detection results. An error injection circuit outputs predetermined error signals at a predetermined timing. A selection circuit selects either the outputs of the error detection circuits or the outputs of the error injection circuit in accordance with a mode signal, and determines the selected outputs as an output of an error register.

### CROSS-REFERENCE TO RELATED APPLICATIONS

The disclosure of Japanese Patent Application No. 2016-034456 filed on Feb. 25, 2016 including the specification, drawings and abstract is incorporated herein by reference in its entirety.

### BACKGROUND

The present invention relates to a semiconductor device and, for example, relates to a semiconductor device having a function of error generation in association with a functional safety test.

For example, Japanese Unexamined Patent Application Publication No. Hei 5(1993)-173829 describes an error generation method that enables clipping inside an LSI (Large Scale Integration) and clipping at an intended timing. Specifically, the LSI includes an MPU, a diagnostic register allowing an access from the MPU thereto, and an error generation circuit generating an error based on a value of the diagnostic register. The MPU receives an instruction of writing to the diagnostic register at a predetermined timing from an external device and executes this instruction, thereby causing the error generation circuit to generate a pseudo error.

### SUMMARY

In particular, to a system required to have high reliability, an arrangement called functional safety is applied. The system to which functional safety (specifically, a fail safe function) is applied can avoid a situation where a serious problem occurs by performing various types of safety operations in accordance with the type or the like of an error, even in a case where the error occurs inside the system, for example. In order to ensure a normal operation of such functional safety, a test is required in which an error is injected to the inside of the system and a subsequent operation is confirmed.

In a case where the system includes an LSI, injection of the error to the inside of the LSI is required in order to perform the functional safety test. To meet this requirement, it is considered to use a method that causes the LSI itself to generate an internal pseudo error, as described in Japanese Unexamined Patent Application Publication No. Hei 5(1993)-173829, for example. However, in this method, a complicated arrangement may be required in association with generation of the pseudo error.

Embodiments described later have been made in view of the above situations. Other problems and novel features will be apparent from the description of this specification and the accompanying drawings.

A semiconductor device according to an embodiment is configured by a single semiconductor chip, and includes an error detection circuit, an error injection circuit, an error register, and a selection circuit. The error detection circuit detects an error generated in the semiconductor device and outputs a first error signal that is a result of the detection. The error injection circuit outputs a predetermined second error signal at a predetermined timing. The selection circuit selects either an output of the error detection circuit or an output of the error injection circuit in accordance with a mode signal, and determines the selected output as an output of the error register.

According to the embodiment, it is possible to cause the semiconductor device to generate an internal pseudo error easily.

### BRIEF DESCRIPTION OF THE DRAWINGS

FIG. 1 schematically illustrates a configuration example of a semiconductor device according to a first embodiment of the present invention.

FIG. 2A is a flowchart illustrating a main operation example of the semiconductor device of FIG. 1.

FIG. 2B is a flowchart illustrating the main operation example of the semiconductor device of FIG. 1.

FIG. 3 is a block diagram illustrating a configuration example of the semiconductor device of FIG. 1 in a case where the semiconductor device is a microcontroller.

FIG. 4 is a circuit block diagram illustrating a configuration example of an error injection circuit in the microcontroller of FIG. 3.

FIG. 5 is a circuit block diagram illustrating a configuration example of a trigger generation circuit in FIG. 4.

FIG. 6 schematically illustrates an example of a register setting method in the error injection circuit in FIGS. 4 and 5.

FIG. 7 schematically illustrates a structure example of an error register in the microcontroller of FIG. 3.

FIG. 8 schematically illustrates an example of timings of internal processes associated with a functional safety test in the semiconductor device of FIG. 1.

FIG. 9 is a block diagram illustrating a configuration example of a semiconductor device (microcontroller) according to a second embodiment of the present invention.

FIG. 10 schematically illustrates a configuration example of an electronic control unit and a configuration example of a vehicle device that are application examples of a semiconductor device according to a third embodiment of the present invention.

FIG. 11 is a block diagram illustrating a configuration example of a semiconductor device according to a fourth embodiment of the present invention and its surroundings.

FIG. 12 schematically illustrates a configuration example of a semiconductor device according to a fifth embodiment of the present invention.

FIG. 13 schematically illustrates a configuration example of a semiconductor device studied as a comparative example of the present invention.

### DETAILED DESCRIPTION

The following embodiments will be described while being divided into a plurality of sections or embodiments, if necessary for the sake of convenience. However, unless otherwise specified, these are not independent of each other, but are in a relation such that one is a modification example, details, complementary explanation, or the like of a part or the whole of the other. In the following embodiments, when a reference is made to the number of elements, and the like (including number, numerical value, quantity, range, and the like), the number of elements is not limited to the specific number, but may be greater than or less than the specific number, unless otherwise specified, or except the case where the number is apparently limited to the specific number in principle, or except for other cases.

Further, in the following embodiments, the constitutional elements (including element steps, or the like) are not always essential, unless otherwise specified, or except the case where they are apparently considered essential in principle, or except for other cases. Similarly, in the following embodiments, when a reference is made to the shapes, positional relationships, or the like of the constitutional elements, or the like, it is understood that they include ones substantially analogous or similar to the shapes or the like, unless otherwise specified, or unless otherwise considered apparently in principle, or except for other cases. This also applies to the foregoing numbers and ranges.

Embodiments of the present invention are described in detail below. Throughout the drawings for explaining embodiments, the same component is labeled with the same reference sign and the redundant description thereof is omitted.

### First Embodiment

### <<Schematic Configuration of Semiconductor Device>>

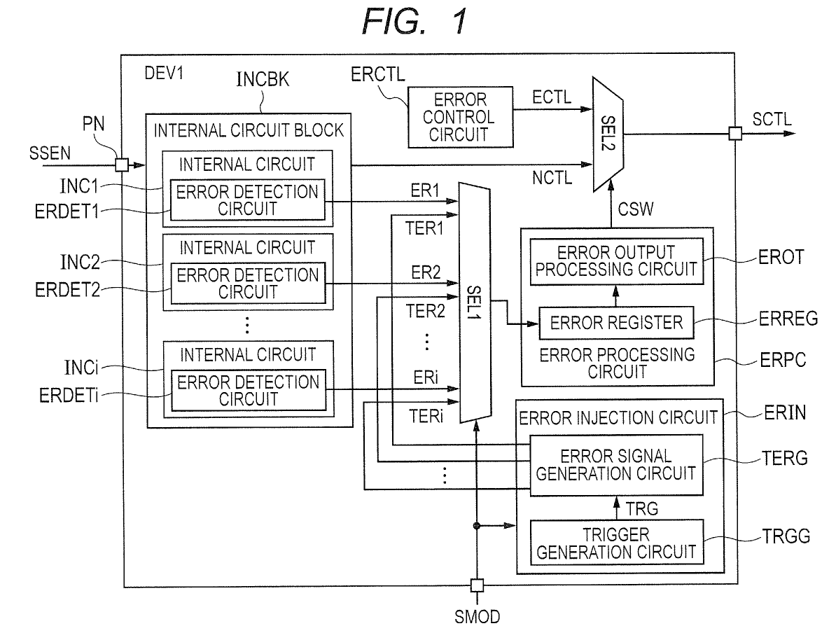

FIG. 1 schematically illustrates a configuration example of a semiconductor device according to a first embodiment of the present invention. The semiconductor device DEV1 illustrated in FIG. 1 is configured by a single semiconductor chip, and includes a plurality of external terminals PN and various types of circuits. The external terminals include an external terminal PN(SCTL) outputting a control signal SCTL to an external device (not illustrated), an external signal PN(SSEN) to which a sensor signal SSEN from various types of external sensor circuits (not illustrated), and an external terminal PN(SMOD) to which a mode signal SMOD is input. The mode signal SMOD is set to a logic level for normal operation (hereinafter, referred to as a normal level) or a logic level for test (hereinafter, referred to as a test level).

The various types of circuits include a internal circuit block INCBK, an error injection circuit ERIN, an error processing circuit ERPC, selection circuits SEL1 and SEL2, and an error control circuit ERCTL. The internal circuit block INCBK includes a plurality of (i in this example) internal circuits INC1 to INCi that receive the sensor signal SSEN and perform a predetermined process. The internal circuit block INCBK outputs a normal control signal NCTL based on processed results of the respective internal circuits INC1 to INCi.

The internal circuits INC1 to INCi include error detection circuits ERDET1 to ERDETi, respectively. The error detection circuits ERDET1 to ERDETi detect an error (e.g., a failure) occurring in the respective internal circuit INC1 to INCi and output error signals ER1 to ERi that are detection results. For example, the error detection circuit ERDET1 outputs the error signal ER1 having a predetermined number of bits (e.g., 1 bit or several bits) when detecting the error in the internal circuit INC1. The error detection circuit ERDETi outputs the error signal ERi having the predetermined number of bits when detecting the error in the internal circuit INCi.

The error injection circuit ERIN includes a trigger generation circuit TRGG that generates a trigger signal TRG at a predetermined timing and an error signal generation circuit TERG that outputs test error signals TER1 to TERi in response to the trigger signal TRG. The error injection circuit ERIN operates when the mode signal SMOD is at the test level to output predetermined test error signals TER1 to TERi at the predetermined timing by using the trigger generation circuit TRGG and the error signal generation circuit TERG.

The error processing circuit ERPC includes an error register ERREG for holding various types of error signals generated in the internal circuit block INCBK and, an error output processing circuit EROT that determines the held content (that is, an error content) of the error register ERREG and performs various types of error outputs in accordance with the error content. The error outputs include a control switching signal CSW output in a case where a relatively serious error occurs in the internal circuit block INCBK, for example.

The selection circuit SEL1 selects either the output of the error detection circuit (that is, the error signals ER1 to ERi) or the output of the error injection circuit (that is, the test error signals TER1 to TERi) in accordance with the mode signal SMOD, and determines the selected output as an output of the error register ERREG. Specifically, the selection circuit SEL1 receives the outputs of the error detection circuits ERDET1 to ERDETi and the output of the error injection circuit ERIN that are input thereto, selects the outputs of the error detection circuits when the mode signal SMOD is at the normal level, selects the output of the error injection circuit when the mode signal SMOD is at the test signal, and writes the selected output into the error register ERREG.

The error control circuit ERCTL outputs the error control signal ECTL for performing a safety operation in a case where a relatively serious error occurs in the internal circuit block INCBK, for example. For example, the normal control signal NCTL is a closed-loop control circuit based on feedback from the sensor signal SSEN, whereas the error control signal ECTL is an open-loop control signal not based on such feedback. However, the normal control signals NCTL and the error control signal ECTL are not specifically limited thereto.

The selection signal SEL2 selects one of the normal control signal NCTL and the error control signal ECTL in accordance with the control switching signal CSW, and outputs the selected signal as a control signal SCTL to the external terminal PN(SCTL). Specifically, the selection circuit SEL2 outputs the normal control signal NCTL in a case where the control switching signal CSW is not output (in other words, is negated), and outputs the error control signal ECTL in a case where the control switching signal CSW is output (in other words, is asserted).

### <<Schematic Operation of Semiconductor Device>>

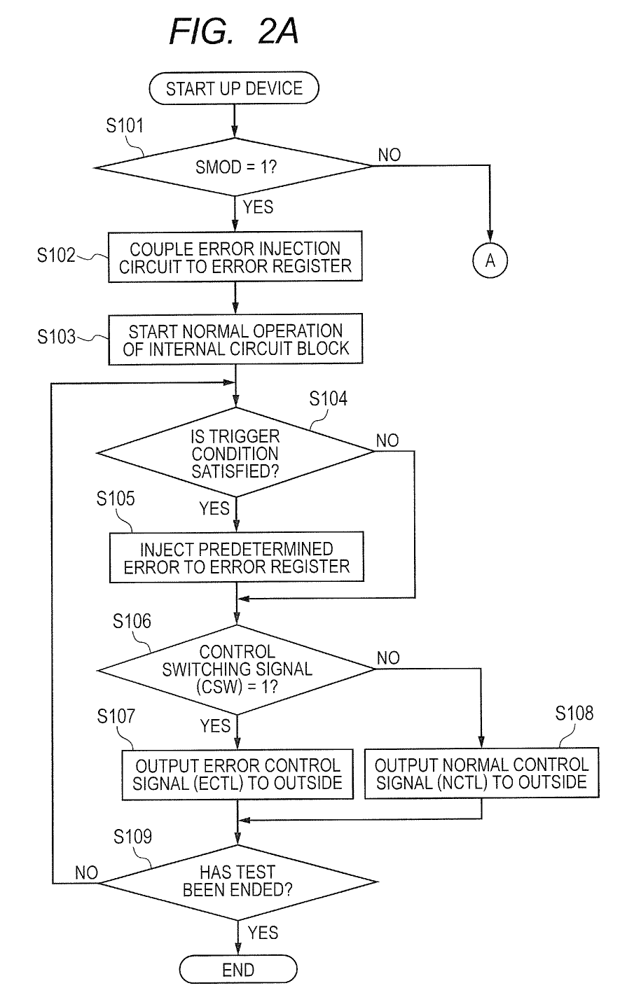

FIGS. 2A and 2B are flowcharts of a main operation example of the semiconductor device of FIG. 1. In FIG. 2A, a system developer or the like who builds a system including the semiconductor device DEV1 of FIG. 1, for example, starts up the semiconductor device DEV1 while the mode signal SMOD of the external terminal PN(SMOD) is set to the test level (‘1’ in this example) or the normal level (‘0’ in this example). At the start up, the semiconductor device DEV1 proceeds to a process in Step S102 of FIG. 2A when the mode signal SMOD is at the test level, and proceeds to a process in Step S111 of FIG. 2B when the mode signal SMOD is at the normal level.

In Step S102 of FIG. 2A, the selection circuit SEL1 couples the output of the error injection circuit ERIN (that is, the test error signals TER1 to TERi) to the error register ERREG. In this state, the internal circuit block INCBK starts a normal operation and starts outputting the normal control signal NCTL (Step S103). Meanwhile, in parallel with this process, the error injection circuit ERIN determines by using the trigger generation circuit TRGG whether or not a predetermined trigger condition is satisfied, while outputting initial values (specifically, that are signals indicating no error) as the test error signals TER1 to TERi (Step S104).

In a case where the predetermined trigger condition is satisfied in Step S104, the error injection circuit ERIN injects an error to the error register ERREG (Step S105). Specifically, the error injection circuit ERIN outputs predetermined test error signals TER1 to TERi by using the error signal generation circuit TERG, and writes those into the error register ERREG via the selection circuit SEL1. Thereafter, the semiconductor device DEV1 proceeds to a process in Step S106. On the other hand, in a case where the predetermined trigger condition is not satisfied in Step S104, the semiconductor device DEV1 proceeds to the process in Step S106 not via the process in Step S105.

In Step S106, the selection circuit SEL2 determines whether the control switching signal CSW is asserted (‘1’ in this example) or negated (‘0’ in this example), and outputs the error control signal ECTL to the external terminal PN(SCTL) when the control switching signal CSW is asserted (Step S107). That is, when the error output processing circuit EROT asserts the control switching signal CSW in accordance with the held content of the error register ERREG, the error control signal ECTL is output to the outside. Meanwhile, the selection circuit SEL2 outputs the normal control signal NCTL to the external terminal PN(SCTL) when the control switching signal CSW is negated (Step S108). Thereafter, the semiconductor device DEV1 returns to Step S104 and repeats the processes until the system developer or the like ends the test (Step S109).

Meanwhile, in Step S111 in FIG. 2B, the selection circuit SEL1 couples the outputs of the internal circuit block INCBK to the error register ERREG (that is, the error signals ER1 to ERi). In this state, the internal circuit block INCBK starts the normal operation and starts outputting the normal control signal NCTL (Step S112).

The selection circuit SEL2 then determines whether the control switching signal CSW is asserted (‘1’ in this example) or negated (‘0’ in this example), and outputs the error control signal ECTL to the external terminal PN(SCTL) when the control switching signal CSW is asserted (Step S115). That is, in a case where the error detection circuits ERDET1 to ERDETi detect an error during the operation of the internal circuit block INCBK and the error output processing circuit EROT asserts the control switching signal CSW in response to the detection, the error control signal ECTL is output to the outside.

Meanwhile, the selection circuit SEL2 outputs the normal control signal NCTL to the external terminal PN(SCTL) when the control switching signal CSW is negated (Step S114). Thereafter, the semiconductor device DEV1 returns to Step S113 and repeats the processes until it ends the predetermined operation (Step S116).

### <<Configuration of Microcontroller>>

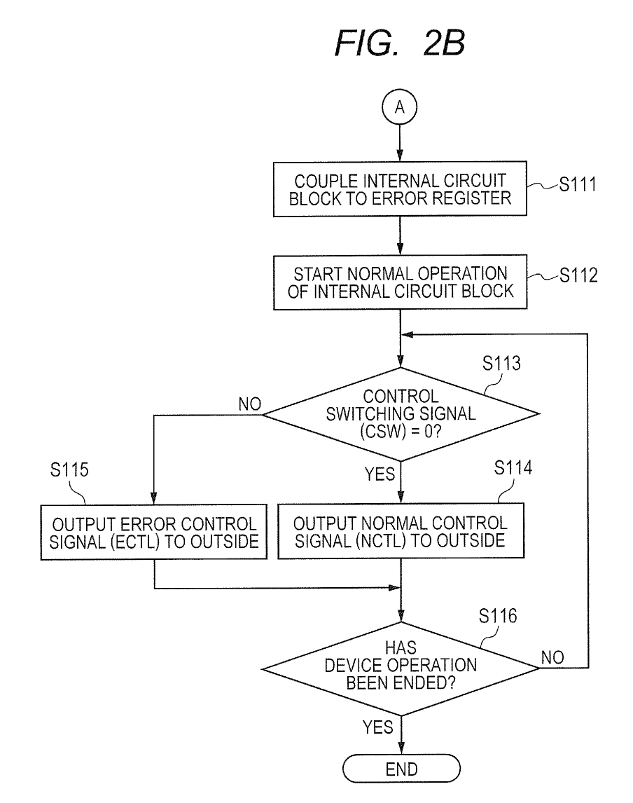

FIG. 3 is a block diagram illustrating a configuration example in a case where the semiconductor device of FIG. 1 is a microcontroller. In the microcontroller (semiconductor device) MCU1 of FIG. 3, a processor circuit CPU, a BIST (Built In Self Test) circuit BISTC, a volatile memory circuit RAM, and a control-signal interface circuit CTLIF are coupled to a bus BS. Among those components, the processor circuit CPU, the BIST (Built In Self Test) circuit BISTC, and the volatile memory circuit RAM respectively correspond to the internal circuits INC1 to INCi each including the error detection circuit illustrated in FIG. 1.

The processor circuit CPU is a lock step dual core including a master core MCR, a checker core CCR, and an error detection circuit ERDETc in this example. The master core MCR and the checker core CCR execute together a main body program MPRG held by a non-volatile memory circuit ROM, such as a flash memory. The error detection circuit ERDETc compares an execution result of the master core MCR and an execution result of the checker core CCR, and determines that the execution result of the master core MCR is normal when the comparison result is the same. On the other hand, when the comparison result is different, the error detection circuit ERDETc determines that the execution result of the master core MCR is abnormal, and outputs an error signal ER1 (that is, asserts the error signal ER1.)

The volatile memory circuit RAM includes a memory hard macro MEMHM, such as an SRAM (Static RAM) or a DRAM (Dynamic RAM), and an error detection circuit ERDETm, for example. The error detection circuit ERDETm performs error detection and error correction for data of an access to the memory hard macro MEMHM by using an ECC (Error Correcting Code), for example. The error detection circuit ERDETm outputs an error signal ER2 when having performed error detection. The volatile memory circuit RAM is used for various purposes typified by a work memory for the processor circuit CPU, for example.

The BIST circuit BISTC includes a logic test circuit LBIST, a memory test circuit MBIST, and an error detection circuit ERDETb. The logic test circuit LBIST texts various types of logic circuits in the microcontroller MCU1 via the bus BS, and the memory test circuit MBIST tests various types of memory circuits in the microcontroller MCU1 via the bus BS. The error detection circuit ERDETb outputs an error signal ER3 when a test result in each test circuit is defective. The BIST circuit BISTC is used as a self diagnosis circuit at a start time of the microcontroller MCU1, for example.

The microcontroller MCU1 includes external terminals PN(ENA), PN(JTAG), PN(TRGIN), and PN(ERFLG) in addition to the external terminal PN(SMOD) for the mode signal SMOD and the external terminal PN(SCTL) for the control signal SCTL illustrated in FIG. 1. To the external terminal PN(ENA), a start-up signal ENA of the microcontroller MCU1 (specifically, the processor circuit CPU, for example) is input. To the external terminal PN(TRGIN), an external trigger signal TRGIN is input. The external terminal PN(ERFLG) outputs an error flag signal ERFLG.

The external terminal PN(JTAG) is an external terminal for a JTAG (Joint Test Action Group) signal, and is configured by a TDI (Test Data In) terminal, TDO (Test Data Out) terminal, a TCK (Test Clock) terminal, a TMS (Test Mode Select) terminal, and a TRST (Test Reset) terminal. Also, although not illustrated, the microcontroller MCU1 actually includes the external terminal PN for the sensor signal SSEN in FIG. 1. The sensor signal SSEN is input to the processor circuit CPU and the like via the bus BS, for example.

The processor circuit CPU generates a control signal in accordance with the sensor signal SSEN and the like based on the main body program MPRG, and outputs the control signal to the control-signal interface circuit CTLIF via the bus BS. The control-signal interface circuit CTLIF receives the control signal from the processor circuit CPU and outputs the normal control signal NCTL. At this time, the control-signal interface circuit CTLIF performs, for the control signal from the processor circuit CPU, for example, a process that generates the normal control signal NCTL by performing format conversion, timing adjustment, or the like, or a process that generates the normal control signal NCTL by performing a predetermined calculation in some cases.

The error injection circuit ERIN includes the trigger generation circuit TRGG and the error signal generation circuit TERG, as in the case of FIG. 1, and outputs the test error signals TER1 to TER3. In this example, to the error injection circuit ERIN, the start-up signal ENA, a program counter PC, the JTAG signal, and the external trigger signal TRGIN are input, in addition to the mode signal SMOD. The program counter PC indicates a program execution address in the processor circuit CPU (for example, the master core MCR).

Selection circuits SEL1a to SEL1c correspond to the selection circuit SEL1 in FIG. 1, and select either outputs of the error detection circuits ERDETc, ERDETm, and ERDETb or the outputs of the error injection circuit ERIN in accordance with the mode signal SMOD to write the selected outputs to the error register ERREG of the error processing circuit ERPC. The error output processing circuit EROT of the error processing circuit ERPC outputs a reset signal RST, an interrupt signal INTC, and the error flag signal ERFLG, in addition to the control switching signal CSW as in the case of FIG. 1. The reset signal RST and the interrupt signal INTC are input to the processor circuit CPU, for example.

The selection circuit SEL2 selects either the normal control signal NCTL or the error control signal ECTL from the error control circuit ECTL in accordance with the control switching signal CSW, and outputs the selected signal as the control signal SCTL, as in the case of FIG. 1. For example, a plant to be controlled is coupled to the external terminal PN(SCTL). This plant operates based on the control signal SCTL. Sensor circuits and the like (not illustrated) detect various types of change amounts in association with the operation of the plant, and output the sensor signal SSEN that is the detection result.

The error output processing circuit EROT outputs (that is, asserts) the reset signal RST and the error flag signal ERFLG in a case where an error recognized based on the held content of the error register ERREG is a relatively minor error, for example. The processor circuit CPU is reset in accordance with the reset signal RST, and the external plant or the like performs a predetermined error process in accordance with the error flag signal ERFLG.

Meanwhile, the error output processing circuit EROT outputs the control switching signal CSW and the error flag signal ERFLG in a case where the error recognized based on the held content of the error register ERREG is a relatively serious error. When the control switching signal CSW is output, the error control signal ECTL is output from the external terminal PN(SCTL), in place of the normal control signal NCTL.

Specifically, the error control circuit ERCTL is configured by exclusive hardware or is implemented by program processing by the processor circuit CPU, for example. In a case where the error control circuit ERCTL is implemented by the program processing, the non-volatile memory circuit ROM holds an interrupt process program for generating and outputting the error control signal ECTL, for example. The error outputting process circuit EROT outputs the interrupt signal INTC for causing the interrupt process program to be executed, in a case where the aforementioned relatively serious error has occurred. A combination of the held content of the error register ERREG and each output of the error output processing circuit EROT is not limited to this example, but can be determined as appropriate. For this, it is possible to configure the error output processing circuit EROT to allow a system developer or the like to set the combination in an arbitrary manner.

### <<Details of Error Injection Circuit>>

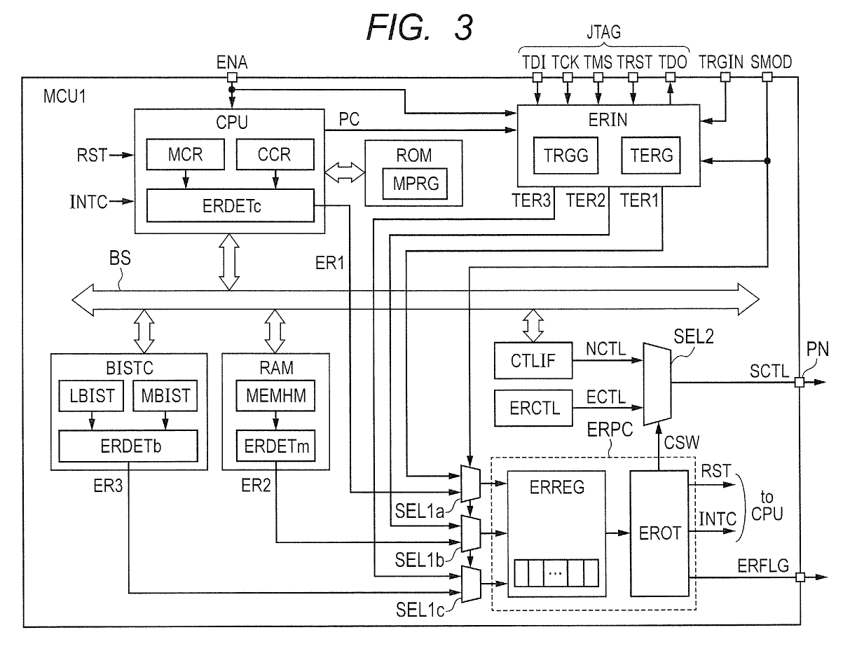

FIG. 4 is a circuit block diagram illustrating a configuration example of the error injection circuit in the microcontroller of FIG. 3. In the error injection circuit ERIN of FIG. 4, the trigger generation circuit TRGG includes a program-counter (may be abbreviated as PC) monitor circuit PCMNI, a timer circuit TMR, and a trigger output circuit TRGO. The PC monitor circuit PCMNI outputs a program-counter coincidence signal PCH when a value of the program counter PC of the processor circuit CPU and a predetermined program-counter setting value are coincident to each other.

The timer circuit TMR starts a timer operation in response to a predetermined timer startup signal, and outputs a timer coincidence signal TMH when reaching a predetermined timer setting value. The trigger output circuit TRGO generates the trigger signal TRG based on at least one of the program-counter coincidence signal PCH, the timer coincidence signal TMH, the external trigger signal TRGIN from the external terminal PN(TRGIN). Although the details will be described later, the trigger output circuit TRGO can also generate the trigger signal TRG based on a combination of these signals.

The error signal generation circuit TERG includes a register control circuit REGCT, a data setting register block DREGBK having one or a plurality of (k in this example) data setting registers DREG1 to DREGk, and a data output register DREGO. Each of the data setting registers DREG1 to DREGk determines test error signals TER1 to TERi. The data output register DREGO actually outputs the test error signals TER1 to TERi.

The register control circuit REGCT initializes values of the data output register DREGO by using an initialization signal INIT in accordance with the mode signal SMOD, for example. Thus, the error signal generation circuit TERG outputs a signal indicating no error as initial values (in other words, the test error signals TERI to TERi that are negated). Further, the register control circuit REGCT loads values of any of the data setting registers DREG1 to DREGi (for example, values of DREG1) to the data output register DREGO by using load enable signals LE1 to LEk, for example, in response to the trigger signal TRG.

Alternatively, the register control circuit REGCT loads values of the data setting registers DREG1 to DREGk in turn to the data output register DREGO every time the trigger signal TRG is input. In this manner, the register control circuit REGCT performs sequence control when the test error signals TER1 to TERi are output. However, the content of this sequence control is not specifically limited to the aforementioned example. The content of the sequence control is determined in accordance with the specific test specification or the like, as appropriate.

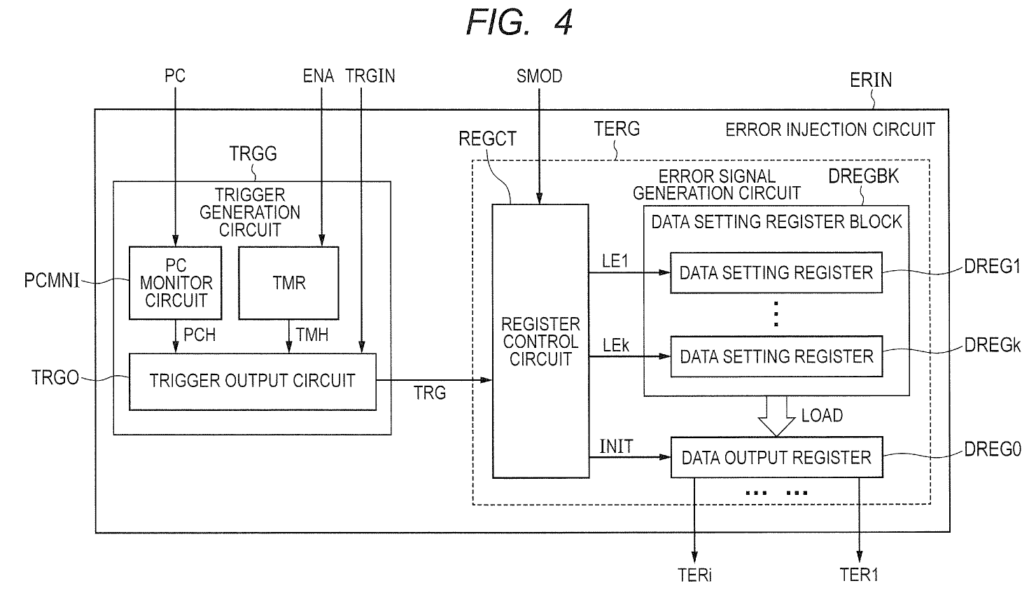

FIG. 5 is a circuit block diagram illustrating a configuration example of the trigger generation circuit in FIG. 4. In the trigger generation circuit TRGG of FIG. 5, the PC monitor circuit PCMNI includes one or a plurality of (j in this example) PC setting registers PRRG1 to PREGj, one or a plurality of (j in this example) EXOR operation circuits EOR1 to EORj, and a NOR operation circuit NR, for example.

The PC setting registers PREG1 to PREGi determine PC setting values, respectively. The EXOR operation circuits EOR1 to EORj each determine whether or not a value of the program counter PC and a PC setting value held in a corresponding one of the PC setting registers PREG1 to PREGj are coincident to each other. The NOR operation circuit NR outputs the program-counter coincidence signal PCH (asserts it to ‘1’ in this example) in a case where all the determination results of the EXOR operation circuits EOR1 to EORj indicate coincidence. Thus, the PC monitor circuit PCMNI can output the program-counter coincidence signal PCH when passing all one or a plurality of PC setting values (that is, one or a plurality of processes on the main body program MPRG).

The timer circuit TMR includes a start-up selection register CSREG, a timer control circuit TMCTL, a counter circuit CUNT, a timer setting register block TREGBK having one or a plurality of (j in this example) timer setting registers TREG1 to TREGj, and a timer comparison circuit TCMP. The timer control circuit TMCTL selects a timer start-up signal that acts as a trigger when the counter circuit CUNT starts a count operation (a timer operation), based on the held content of the start-up selection register CSREG. In this example, the timer start-up signal is selected from the start-up signal ENA from the external terminal PN(ENA), the program-counter coincidence signal PCH, and the external trigger signal TRGIN. The timer control circuit TMCTL issues the timer start-up signal to the counter circuit CUNT when the thus selected signal is asserted.

The timer setting registers TREG1 to TREGi determine timer setting values (counter setting values), respectively. The timer control circuit TMCTL outputs a value of any of the timer setting registers TREG1 to TREGj (for example, a value of TREG1) to the timer comparison circuit TCMP. Alternatively, the timer control circuit TMCTL outputs values of the timer setting registers TREG1 to TREGj in turn to the timer comparison circuit TCMP, every time the timer coincidence signal TMH is output. The timer comparison circuit TCMP determines whether a count value of the counter circuit CUNT and a timer setting value (count setting value) from the timer setting register block TREGBK are coincident to each other, and outputs the timer coincidence signal TMH (asserts it to ‘1’ in this example) when both are coincident.

The trigger output circuit TRGO includes a logic setting register LSREG, selection circuits SEL11 to SEL13, flip-flop circuits FF1 to FF3, a variable logic circuit PLC, and a flip-flop reset circuit FRSC. When the program-counter coincidence signal PCH has been asserted (has transitioned to ‘1’), the selection circuit SEL11 and the flip-flop circuit FF1 hold that ‘1’ level. Similarly, the selection circuit SEL2 and the flip-flop circuit FF2 hold the ‘1’ level with regard to the timer coincidence signal TMH, and the selection circuit SEL3 and the flip-flop circuit FF3 hold the ‘1’ level with regard to the external trigger signal TRGIN.

The variable logic circuit PLC performs a logical operation based on a truth table specified by the held content of the logic setting register LSREG by using the outputs of the flip-flop circuits FF1 to FF3 as inputs, and outputs the trigger signal TRG that is the result of the logical operation. In response to assertion of the trigger signal TRG, the flip-flop reset circuit FRSC issues a flip-flop reset signal FR after a predetermined time period has passed, thereby resetting the flip-flop circuits FF1 to FF3 (changes those to ‘0’ level in this example). The flip-flop reset circuit FRSC is used in a case where the trigger signal TRG is generated multiple times sequentially based on the timer setting registers TREG1 to TREGj, for example.

With the configuration illustrated in FIGS. 4 and 5, it is possible to inject an error determined in the data setting register (for example, DREG1) at any of timings based on the program-counter coincidence signal PCH, the timer coincidence signal TMH, and the external trigger signal TRGIN after the start-up signal ENA is input, for example. In other words, it is possible to inject the error when a predetermined process (that is, a process determined by the PC setting value) is started after the processor circuit CPU starts execution of the main body program MPRG, or when a predetermined time period (that is, a time period determined by the timer setting value) has passed. Alternatively, it is possible to inject the error at an arbitrary timing by using the external trigger signal TRGIN.

Further, it is possible to inject the error at a timing determined by a combination of the program-counter coincidence signal PCH, the timer coincidence signal TMH, and the external trigger signal TRGIN. For example, when the timer start-up signal is set as the start-up signal ENA and a combination of the program-counter coincidence signal PCH and the timer coincidence signal TMH (for example, an OR operation) is used, it is possible to inject the error at either one of timings that is earlier.

In addition, when the timer start-up signal is set as the program-counter coincidence signal PCH and the trigger signal TRG is generated by using the timer coincidence signal TMH, for example, it is possible to inject the error after a predetermined time period has passed after start of a predetermined process by the processor circuit CPU. Similarly, when the timer start-up signal is set as the external trigger signal TRGIN and the trigger signal TRG is generated by using the timer coincidence signal TMH, it is possible to inject the error after a predetermined time period has passed after application of the external trigger signal TRGIN.

With the configuration illustrated in FIGS. 4 and 5, it is possible to determine various error injection conditions typified the above operations. Then, with regard to a system including this microcontroller as an object, a system developer or the like can test behaviors after injection of an error to the inside of the microcontroller under the various conditions. Consequently, comprehensiveness of a system test can be improved. The configuration of the error injection circuit ERIN is not necessarily limited to the configuration illustrated in FIGS. 4 and 5, but any configuration can be applied and changed as long as that configuration allows a predetermined error to be injected at a timing based on any of the program-counter coincidence signal PCH, the timer coincidence signal TMH, and the external trigger signal TRGIN, or a combination thereof. For example, a circuit outputting the program-counter coincidence signal PCH when passing the same PC setting value multiple times, can be added to the PC monitor circuit PCMNI.

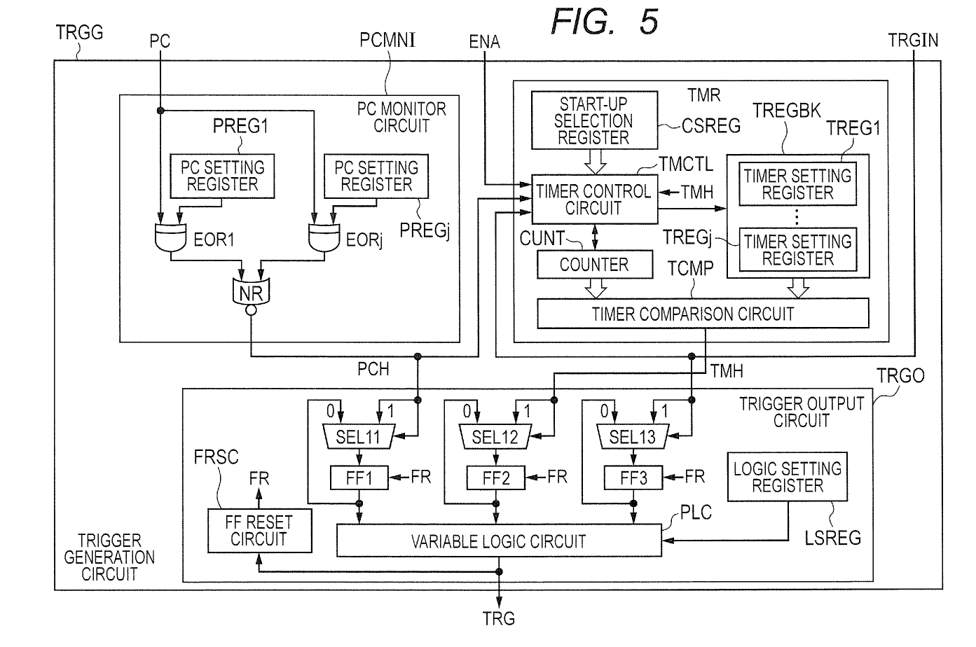

FIG. 6 schematically illustrates an example of a register setting method in the error injection circuit of FIGS. 4 and 5. As illustrated in FIG. 6, respective setting registers in the PC monitor circuit PCMNI, the timer circuit TMR, the trigger output circuit TRGO, and the error signal generation circuit TERG are coupled by a scan chain SC between the TDI terminal and the TDO terminal that constitute the external terminal PN(JTAG) for JTAG.

The respective setting registers are the program-counter setting registers PREG1 to PREGj, the start-up selection register CSREG, the timer setting registers TREG1 to TREGi, the logic setting registers LSREG, and the data setting registers DREG1 to DREGk. Due to this, a system developer or the like can set a predetermined value to each setting register by accessing the scan chain SC via the external terminal PN(JTAG) for JTAG, as initial setting for test.

### <<Configuration of Error Register>>

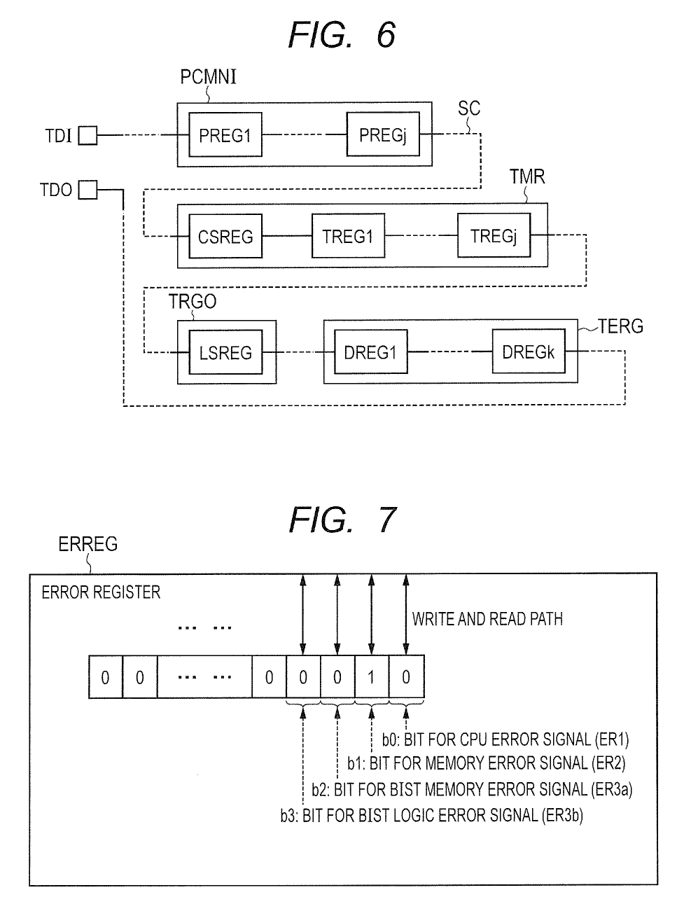

FIG. 7 schematically illustrates a structure example of the error register in the microcontroller of FIG. 3. The error register ERREG illustrated in FIG. 7 has a plurality of bits each of which holds an error signal different from others. For example, bit 0 (b0) holds the error signal ER1 from the error detection circuit ERDETc in the processor circuit CPU in FIG. 3. Bit 1 (b1) holds the error signal ER2 from the error detection circuit ERDETm in the volatile memory circuit RAM in FIG. 3.

Bit 2 (b2) and bit 3 (b3) hold the error signal ER3 from the error detection circuit ERDETb in the BIST circuit BISTC in FIG. 3. In this example, the error signal ER3 is 2-bit. One of the bits holds an error signal ER3a by the memory test circuit MBIST, and the other bit holds an error signal ER3b by the logic test circuit LBIST.

FIG. 7 illustrates a state where the error signal ER2 is asserted by the error detection circuit ERDETm (for example, an ECC error occurs). Each of the data setting registers DREG1 to DREGk in FIG. 4 has the same number of bits as the error register ERREG, but not limited thereto necessarily. In a case where such an ECC error is injected by the error injection circuit ERIN, data illustrated in FIG. 7 is set in advance in the data setting register DREG1, for example.

### <<Schematic Operation of Microcontroller>>

Next, a method of a functional safety test, using the microcontroller MCU1 in FIG. 3, is briefly described. A basic test method is the same as that in the case of FIG. 2A described before. First, a system developer or the like can perform the functional safety test by setting the mode signal SMOD to the test level when the microcontroller MCU1 is started-up (for example, is turned on). In this state, the system developer or the like accesses the scan chain SC in FIG. 7 via the external terminal PN(JTAG) for JTAG and sets a predetermined value in each setting register, thereby determining various conditions of error injection.

Subsequently, the system developer or the like asserts the start-up signal ENA, and, in response to this, the processor circuit CPU starts execution of the main body program MPRG. In this stage, initial values of the data output register DREGO in FIG. 4 (i.e., signals indicating no error) are input to the error register ERREG. Thereafter, when a trigger condition is satisfied based on each setting register, the error injection circuit ERIN injects an error based on each setting register to the error register ERREG. By checking an operation after this error injection, the system developer or the like tests whether functional safety operates normally. Also, the system developer or the like can perform the functional safety test comprehensively by repeating such a test while changing various types of conditions of error injection as appropriate.

### <<Main Advantageous Effects of First Embodiment>>

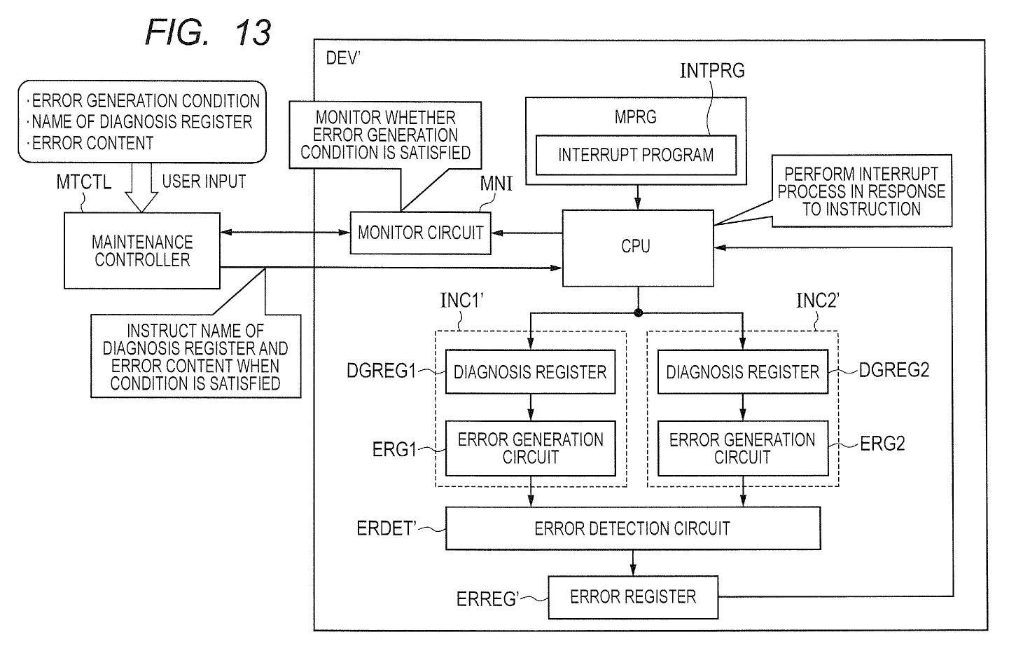

FIG. 13 schematically illustrates a configuration example of a semiconductor device studied as a comparative example of the present invention. The semiconductor device DEV′ illustrated in FIG. 13 includes a plurality of internal circuits INC1′ and INC2′ that respectively include diagnosis registers DGREG1 and DGREG2 and error generation circuits ERG1 and ERG2. In the main body program MPRG of the processor circuit CPU, an interrupt process program INTPRG is specially provided.

Outside the semiconductor device DEV′, a maintenance controller MTCTL configured by a computer system or the like is provided. A system developer or the like determines an error generation condition (e.g., a program-counter value), the name of the diagnosis register, and an error content by using the maintenance controller MTCTL in advance. The maintenance controller MTCTL notifies the semiconductor device DEV′ of the error generation condition. In accordance with this, a monitor circuit MNI in the semiconductor device DEV′ monitors whether the error generation condition is satisfied.

When being notified that the error generation condition is satisfied from the monitor circuit MNI, the maintenance controller MTCTL notifies the processor circuit CPU of a combination of the name of the diagnosis register (for example, assumed to be DREG1) and the error content via an interrupt signal. The processor circuit CPU executes the interrupt process program INTPRG in response to the interrupt signal, and writes the error content into the diagnosis register DREG1 in this program. The error generation circuit ERG1 generates an error in accordance with the error content of the diagnosis register DGREG1. An error detection circuit ERDET′ detects the generated error and writes information on the detected error into an error register ERREG′. The processor circuit CPU recognizes occurrence of the error by referring to the error register ERREG′.

For example, when this method is used, it is likely that a complicated arrangement is required in association with generation of a pseudo error. As a specific example, first, it is necessary to provide the diagnosis register DREG1, DREG2 and the error generation circuit ERG1, ERG2 in every internal circuit INC1′, INC2′. This causes an overhead of a circuit area. Second, it is necessary to provide the interrupt process program INTPRG for test. This asks the system developer or the like to make a change to the main body program MPRG, which is unnecessary originally, (or a change affecting the main body program MPRG) owing to the semiconductor device DEV′.

Third, it is necessary to install a special external device like the maintenance controller MTCTL when the semiconductor device DEV′ is caused to generate the pseudo error in an actual functional safety test. That is, the system developer or the like has to perform the test while such an external device is specially coupled to a system to be tested (including the semiconductor device DEV′), and therefore it may become complicated to build a test environment, for example.

Meanwhile, in the method of the first embodiment illustrated in FIG. 1 and FIG. 3 and the like, an arrangement is provided that allows a direct access to the error register ERREG not via the processor circuit CPU. Therefore, it is possible to cause the semiconductor device DEV1 to generate an internal pseudo error easily. In other words, it is possible to make a functional safety test to be performed for an actual physical system easier.

Specifically, first, it is not necessary to provide the diagnosis register and the error generation circuit in the case of FIG. 13. In other words, from a viewpoint of the system developer or the like, when the functional safety test is performed, it is not necessary to perform the test to include an error detection mechanism in the semiconductor device DEV1, but it suffices that a final output of the error detection mechanism (that is, the output of the error register ERREG) is obtained.

Second, it is unnecessary to make a change to the main body program MPRG, and is therefore unnecessary to impose a load that is not required originally on the system developer or the like. For example, in a case where the main body program MPRG has been changed, it is likely that a situation occurs where the system developer or the like is asked to perform verification of the main body program MPRG, that has been performed once, again. Third, when the semiconductor device DEV1 is caused to generate the pseudo error in the actual functional safety test, a special external device (maintenance controller) in the case of FIG. 13 is not required. Instead, a usually used test device can be used. In other words, the test device can usually access an external terminal for JTAG. As a result of these, it is possible to cause the semiconductor device DEV1 to generate the internal pseudo error easily.

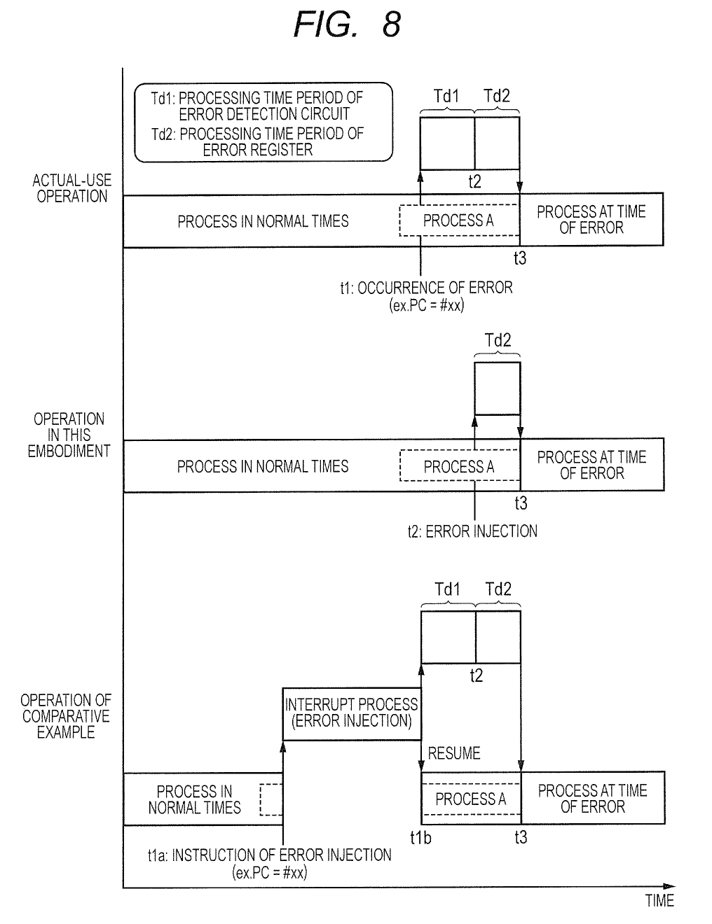

Further, as another advantageous effect, it is possible to prevent detection omission or the like in the test, because the functional safety test can be performed under a circumstance that is close to an actual-use operation. FIG. 8 schematically illustrate an example of timings of internal processes in association with the functional safety test in the semiconductor device of FIG. 1. In FIG. 8, the timings of the internal processes of the semiconductor device are illustrated in a case where an error has occurred in an actual-use operation, a case where an error is injected using the method of this first embodiment, and a case where the error is injected using the method of the comparative example (FIG. 13), respectively.

In the actual-use operation, the processor circuit CPU executes processes in normal times based on the main body program MPRG and executes a process A as one of the processes in normal times. While the processor circuit CPU executes the process A, an error occurs at a time t1 at which processing for a program counter PC=“#xx” is being performed, for example. However, the processor circuit CPU continues to execute the process A even after the time t1.

Meanwhile, in parallel to execution of the process A by the processor circuit CPU, a predetermined error detection circuit detects the error occurred at the time t1, and writes error information into the error register ERREG at a time t2 after a predetermined processing time (a time period Td1) has passed. When writing to the error register ERREG has been performed, switching from the process in normal times by the processor circuit CPU to a process in an error case by the error control circuit ERCTL is performed at a time t3 at which a predetermined error processing time (a time period Td2) based on that error information has passed.

By using the method of this first embodiment, it is possible to perform a functional safety test under a circumstance that is close to the above actual-use operation. That is, as illustrated in FIG. 8, when error injection is performed at the time t2, for example, a circumstance can be reproduced in which an error occurs during execution of the process A and switching of the process is performed at the time t3, as in the case of the actual-use operation. In this case, as described in FIG. 5, when “#xx” is set in the PC setting register PREG1 and the time period Td1 is set in the timer setting register TREG1, for example, error injection is performed at a timing at which the time period Td1 has passed after the program counter PC has reached “#xx”, so that a circumstance that is closer to the actual-use operation can be reproduced.

On the other hand, when the method of the comparative example (FIG. 13) is used, the maintenance controller MTCTL issues an interrupt signal for instructing error injection at a time t1a at which the processing for the process counter PC=“#xx” is being performed. In response to this signal, the processor circuit CPU suspends the process A and executes an interrupt process, unlike the actual-use operation. After injecting an error in the interrupt process, the processor circuit CPU resumes the process A at a time t1b. As described above, when the method of the comparative example is used, a test is performed under a circumstance where the error occurs while the process A is suspended. Therefore, the circumstance of the actual-use operation cannot be sufficiently reproduced, and a situation may be caused in which a trouble to be detected in a functional safety test cannot be detected.

Although the example of FIGS. 1 and 3 uses a method in which the mode signal SMOD is input from the external terminal PN(SMOD), input of the mode signal SMOD is not limited thereto. For example, a method can be used in which the internal circuit like the processor circuit CPU or the error injection circuit ERIN generates the mode signal SMOD. As a specific example, the processor circuit CPU generates the mode signal SMOD at the test level in response to a test start instruction from the outside, and starts execution of the main body program MPRG in response to the start-up signal ENA input thereafter.

Alternatively, the error injection circuit ERIN is provided with a register determining the level of the mode signal SMOD, and generates the mode signal SMOD at the test level by writing the test level into the register from the external terminal PN(JTAG) for JTAG. However, from a viewpoint of performing a test without changing an original operation of the processor circuit CPU, the method using the external terminal PN(SMOD) or the method using the error injection circuit ERIN is desirable.

Further, in the example of FIGS. 1 and 3, the selection circuit SEL1 selects either the output of the error detection circuit or the output of the error injection circuit, and writes the selected output into the error register ERREG to determine the output of the error register ERREG. However, the present invention is not limited to this configuration. Another configuration can be used, as long as that configuration allows the output of the error register ERREG to be directly determined by a path different from a normal path. Specifically, a configuration can be employed in which a normal error register holding an error signal from the internal circuit block INCBK and a test error register holding a test error signal from the error injection circuit ERIN are provided, and the selection circuit selects one of outputs from these error registers. In this case, the number of the error registers is increased by one as compared with the configuration example of FIGS. 1 and 3. However, as in the case of FIGS. 1 and 3, it is possible to directly determine the output of the error register ERREG by the path different from the normal path.

### Second Embodiment

### <<Configuration of Microcontroller (Modified Example)>>

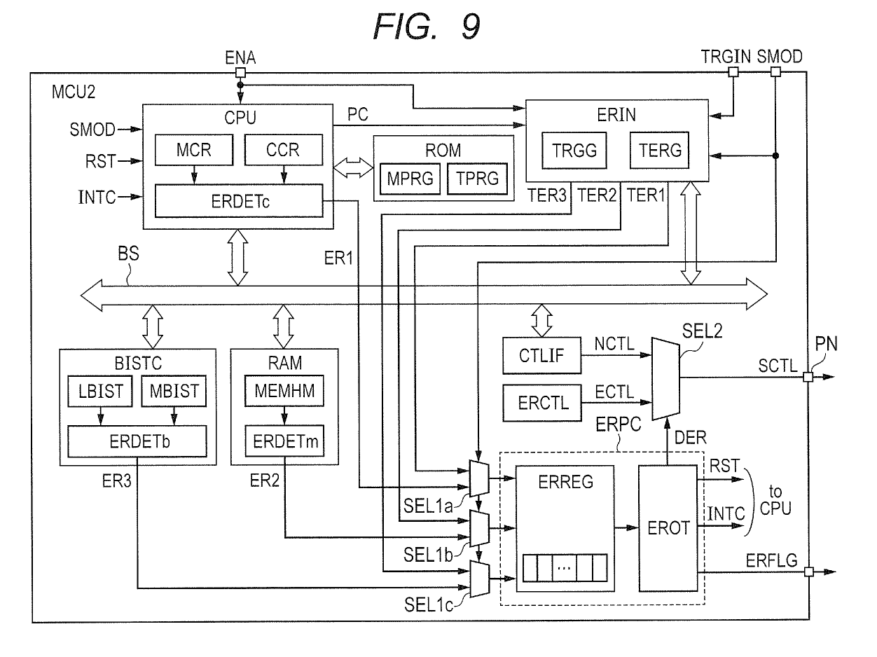

FIG. 9 is a block diagram illustrating a configuration example of a semiconductor device (microcontroller) according to a second embodiment of the present invention. As compared with the configuration example of FIG. 3, the microcontroller MCU2 illustrated in FIG. 9 is different in the following four points. First, the microcontroller MCU2 does not include the external terminal PN(JTAG) for JTAG. Second, the non-volatile memory circuit ROM holds a test initialization program TPRG in addition to the main body program MPRG. Third, the error injection circuit ERIN is coupled to the bus BS. Fourth, the mode signal SMOD is input to the processor circuit CPU.

The test initialization program TPRG includes initial data for test, and is a program causing the processor circuit CPU to write the initial dada for test into each setting register in the error injection circuit ERIN (that is, each setting register illustrated in FIG. 6). The test initialization program TPRG is a program that does not affect the processing of the main body program MPRG and is completely independent of the main body program MPRG. Therefore, a system developer or the like only has to add the test initialization program TPRG in the non-volatile memory circuit ROM without changing the main body program MPRG.

In this configuration, when the microcontroller MCU2 is started up (is turned on) while the mode signal SMOD is placed at the test level, for example, the processor circuit CPU executes the test initialization program TPRG in accordance with the test level of the mode signal SMOD. The processor circuit CPU then performs writing to each setting register in the error injection circuit ERIN via the bus BS, while executing that program. Thereafter, the processor circuit CPU starts execution of the main body program MPRG in response to input of the start-up signal ENA, and subsequently a functional safety test is performed in the same manner as that in the first embodiment.

By using the semiconductor device according to this second embodiment, in addition to various types of advantageous effects described in the first embodiment, it is possible to eliminate the external terminal PN(JTAG) for JTAG, so that the circuit scale, the cost, and the like can be reduced. Further, it is possible to perform a functional safety test even under a circumstance where it is difficult for a test environment of a system to use JTAG (for example, a circumstance where it is difficult to couple a test device to the external terminal PN(JTAG)).

### Third Embodiment

### <<Application Example of Semiconductor Device>>

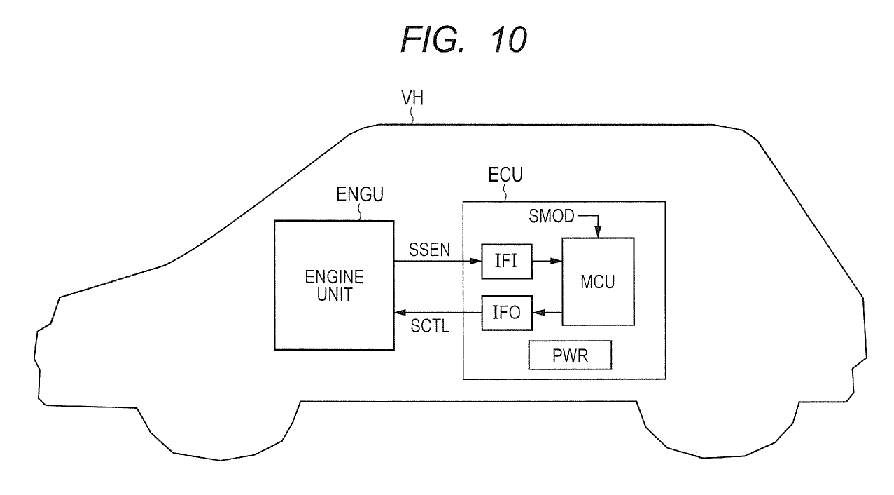

FIG. 10 schematically illustrates a configuration example of an electronic control device and a configuration example of a vehicle device that are application examples of a semiconductor device according to a third embodiment of the present invention. The vehicle device (e.g., an automobile) VH of FIG. 10 includes an engine unit ENGU and an electronic control device ECU (electronic Control Unit) controlling the engine unit ENGU. The engine unit ENGU includes an engine, and further includes various types of actuators that performs fuel injection, valve control, ignition control, and the like for causing the engine to operate, and various types of sensor circuits that sense states of them, although those are not illustrated.

The electronic control device ECU is configured by a single wiring board on which an input interface device IFI, an output interface device IFO, a power-source device PER, a microcontroller (semiconductor device) MCU, and the like are mounted, for example. The power-source device PWR supplies a power source to various devices in the electronic control device ECU. The microcontroller MCU has the configuration of the first embodiment or the second embodiment. To the microcontroller MCU, the sensor signal SSEN from the various types of sensor circuits in the engine unit ENGU is input via the input interface device IFI.

The microcontroller MCU determines an optimum control amount in accordance with the sensor signal SSEN through execution of the main body program MPRG by the processor circuit CPU of FIG. 3, for example. The microcontroller MCU then outputs the control signal SCTL on which that control amount is reflected to the engine unit ENGU via the output interface device IFO. The various types of actuators in the engine unit ENGU operate in accordance with that control signal SCTL.

In an automobile field, for example, it is necessary to ensure a minimum level of traveling and stop even in a case where the microcontroller MCU cannot normally perform the aforementioned operation, because of safety requirements. Therefore, as a fail safe mechanism, the error control circuit ERCTL illustrated in FIG. 3 is provided. The error control circuit ERCTL outputs an actuator control signal for performing a minimum level of engine control.

Nowadays the main body program MPRG that obtains an optimum air-fuel ratio (a ratio of an air to a fuel) by complicated calculation in accordance with a state of an automobile based on various sensor signals SSEN is used to meet requirement of emission control and improvement of fuel efficiency, for example. In a case were an error occurs in a process using such a main body program MPRG, the error control circuit ERCTL outputs the actuator control signal based on a fixed air-fuel ratio that is preset in order to ensure the minimum level of traveling.

In this configuration, in a case of causing the vehicle device VH to perform normal driving, the mode signal SMOD at the normal level is applied to the microcontroller MCU. In this case, if an error is detected in an error detection circuit in the microcontroller MCU, information on that error is written to the error register ERREG. In accordance with this, the engine unit ENGU receives the actuator control signal (SCTL) from the error control circuit ERCTL to operate, in some cases.

However, reliability of the microcontroller MCU for automobile control is usually very high. Therefore, probability of error occurrence is extremely low, and it is not easy to cause a real error in the microcontroller MCU when a functional safety test is performed. Thus, in a case where the functional safety test is needed, the mode signal SMOD at the test level is applied to the microcontroller MCU. Further, various types of error injection conditions are determined by using the method described in the first embodiment or the second embodiment, and a pseudo error based on the error injection conditions is injected to the error register ERREG of the microcontroller MCU.

In this manner, for the electronic control device ECU or the vehicle device VH as a test object, it is possible to test a behavior of the electronic control device ECU or the vehicle device VH in a case where a predetermined error occurs in the microcontroller MCU during execution of a predetermined process by the microcontroller MCU. For example, it is possible to test whether the engine unit ENGU can properly perform a minimum operation (a safety operation).

### Fourth Embodiment

### <<Configuration of Semiconductor Device and Surroundings (Modified Example)>>

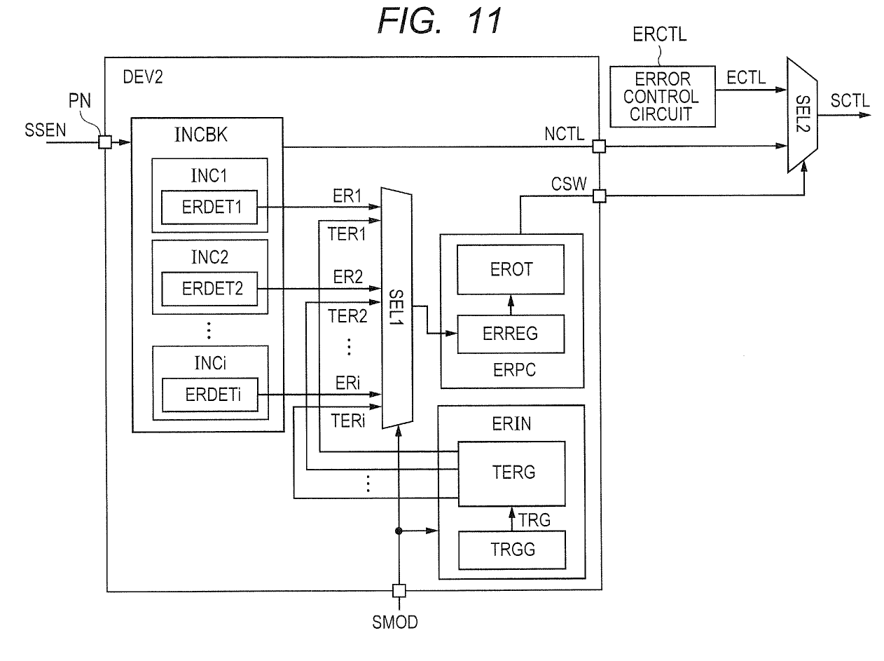

FIG. 11 is a block diagram illustrating a configuration example of a semiconductor device according to a fourth embodiment of the present invention and its surroundings. As compared with the semiconductor device DEV1 of FIG. 1, the semiconductor device DEV2 illustrated in FIG. 11 is different in that the error control circuit ERCTL and the selection circuit SEL2 are provided outside the semiconductor device DEV2. Also, in association with this, the semiconductor device DEV2 does not have the external terminal PN(SCTL). Instead, the semiconductor device DEV2 includes an external terminal PN(NCTL) for outputting the normal control signal NCTL and an external terminal PN(CSW) for outputting the control switching signal CSW.

The error control circuit ERCTL and the selection circuit SEL2 are mounted on the wiring board of the electronic control device ECU illustrated in FIG. 10 as separate components from the semiconductor device DEV2, for example. If the error control circuit ERCTL and the like are provided within the semiconductor device DEV2, a failure in the semiconductor device DEV2 may also affect the error control circuit ERCTL within the same semiconductor chip. With the configuration example of FIG. 11, because the error control circuit ERCTL is a component that is separate from and independent of the semiconductor device DEV2, it is possible to reduce possibility that the aforementioned situation occurs, and the reliability can be further improved in some cases.

### Fifth Embodiment

### <<Schematic Configuration of Semiconductor Device (Application Example)>>

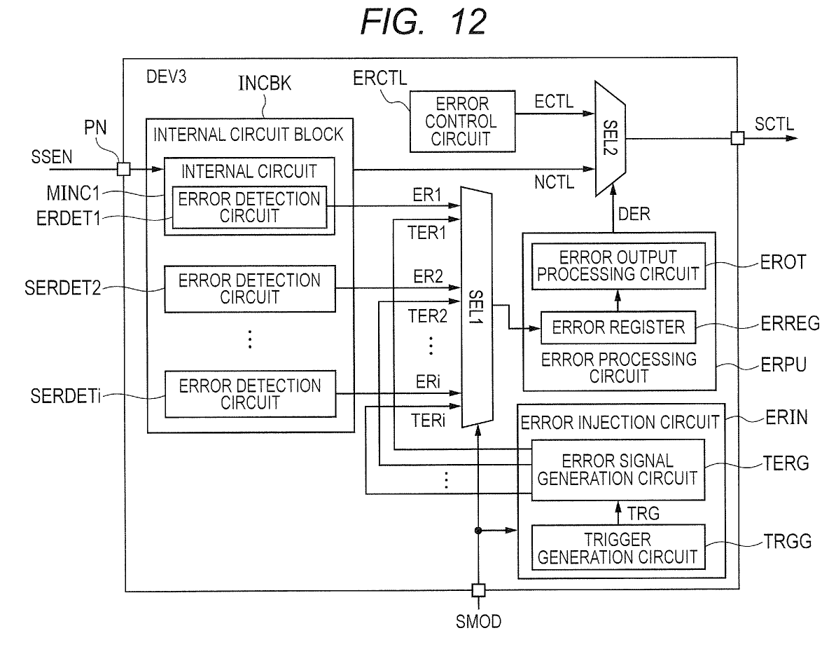

FIG. 12 schematically illustrates a configuration example of a semiconductor device according to a fifth embodiment of the present invention. As compared with the semiconductor device DEV1 of FIG. 1, the semiconductor device DEV3 illustrated in FIG. 12 is different in that it includes an error detection circuit detecting a security error. In the semiconductor device DEV3 of FIG. 12, the internal circuit block INCBK includes an internal circuit MINC1 having an error detection circuit ERDET1, and error detection circuits SERDET2 to SERDETi each operating as a single unit to detect a security error.

The internal circuit MINC1 receives the sensor signal SSEN and outputs the normal control signal NCTL, as in the case of the internal circuits INC1 to INCi in FIG. 1. The error detection circuit ERDET1 detects a failure of the internal circuit MINC1 as an error and outputs the error signal ER1. Meanwhile, each of the error detection circuits SERDET2 to SERDETi detects a security problem typified by an unauthorized access, for example, as an error.

When a microcontroller is described as an example, the error detection circuits SERDET2 to SERDETi respectively correspond to a bus monitor circuit, a memory protection circuit, a watch dog timer, and the like. The bus monitor circuit monitors an unauthorized bus access (for example, an access to an unused address). The memory protection circuit monitors an unauthorized memory access (for example, an access to a protected region). The watch dog timer monitors an execution time period of a program and detects an overtime or the like. The error register ERREG has bits representing the presence/absence of an error associated with a failure, as illustrated in FIG. 7, and also has bits representing the presence/absence of a security error.

When the above configuration example is used, it is typically possible to make the semiconductor device DEV3 easily generate an internal pseudo error as in the case of the first embodiment and the like, so that it is possible to make a functionality safety test, including security protection or the like for an actual physical system as an object, easier. That is, in order to perform the functional safety test, a system developer or the like does not have to start with creating a circumstance in which a security error occurs, for example, performing an unauthorized memory access actually, but can start with a time of occurrence of the security error and can test a subsequent behavior after that.

In the above description, the invention made by the inventors of the present application has been specifically described by way of the embodiments. However, the present invention is not limited to the aforementioned embodiments, and can be changed in various ways within the scope not departing from the gist thereof. For example, while the aforementioned embodiments have been described in detail for clearly explaining the present invention, the present invention is not necessarily limited to forms including all the components explained. Partial replacement is possible between the components of a certain embodiment and the components of another. Likewise, a component of a certain embodiment can be added to another embodiments. Furthermore, with regard to a portion of components of each embodiment, addition, deletion, and replacement of a component is possible.

In this description, the semiconductor device (microcontroller) for automobile is described as an example. However, the present invention is not limited thereto. The present invention can be applied to a semiconductor device for various types of industrial devices required to have relatively high safety in a similar manner, for example.

### <<Appendix>>

A semiconductor device according to an embodiment is configured by a single semiconductor chip, and includes an internal circuit, an error detection circuit, an error injection circuit, an error register, and a selection circuit. The internal circuit executes a predetermined process. The error detection circuit detects an error occurring in the semiconductor device and outputs a first error signal that is a result of the detection. The error injection circuit outputs a predetermined second error signal at a predetermined timing. The selection circuit selects either an output of the error detection circuit or an output of the error injection circuit in accordance with a mode signal, and determines the selected output as an output of the error register.

A test method according to an embodiment is a test method for a system including the semiconductor device, and includes first to third steps. The first step is a step that sets the timing at which the error injection circuit outputs and the second error signal. The second step is a step that determines the mode signal to cause the selection circuit to select the output of the error injection circuit. The third step is a step that causes the internal circuit to execute the predetermined process, after the first step and the second step.

What is claimed is:

1. A semiconductor device configured by a single semiconductor chip, comprising:
an error detection circuit that detects an error occurring in the semiconductor device and outputs a first error signal that is a result of detection;
an error injection circuit that outputs a predetermined second error signal at a predetermined timing;
an error register, and
a selection circuit that selects either an output of the error detection circuit or an output of the error injection signal in accordance with a mode signal, and determines the selected output as an output of the error register.

2. The semiconductor device according to claim 1, further comprising:
a memory circuit holding a main body program, and
a processor circuit executing the main program.

3. The semiconductor device according to claim 2,
wherein the error injection circuit includes
a trigger generation circuit that generates a trigger signal at the predetermined timing, and
an error signal generation circuit that outputs the second error signal in response to the trigger signal, and
wherein the trigger generation circuit includes
a program-counter monitor circuit that outputs a program-counter coincidence signal when a value of a program counter of the processor circuit and a predetermined program-counter setting value are coincident with each other, and
a timer circuit that starts a timer operation in response to a timer start-up signal and outputs a timer coincidence signal when reaching a predetermined timer setting value.

4. The semiconductor device according to claim 3, further comprising an external terminal to which an external trigger signal is input,
wherein the trigger generation circuit generates the trigger signal based on at least one of the program-counter coincidence signal, the timer coincidence signal, and the external trigger signal.

5. The semiconductor device according to claim 3,
wherein the timer start-up signal is the program-counter coincidence signal.

6. The semiconductor device according to claim 3,
wherein the error injection circuit includes
a program-counter setting register determining the program-counter setting value,
a timer setting register determining the timer setting value, and
a data setting register determining the second error signal.

7. The semiconductor device according to claim 1,
wherein the error detection circuit detects a failure in the semiconductor device as the error.

8. The semiconductor device according to claim 1,
wherein the error detection circuit detects an unauthorized access in the semiconductor device as the error.

9. A semiconductor device configured by a single semiconductor chip, comprising:
a bus;
a plurality of internal circuits coupled to the bus, any of which is a processor circuit;
a memory circuit that holds a main body program executed by the processor circuit;
a plurality of error detection circuits that detect an error occurring in the internal circuits and output first error signals that are results of the detection;
an error injection circuit that outputs a signal indicating no error as an initial value and outputs a predetermined second error signal at a predetermined timing;
an error register, and
a selection circuit to which outputs of the error detection circuit and an output of the error injection circuit are input and which selects either one of the outputs in accordance with a mode signal and writes the selected output(s) to the error register.

10. The semiconductor device according to claim 9, further comprising an external terminal for inputting the mode signal from an outside.

11. The semiconductor device according to claim 9,
wherein the error injection circuit includes
a trigger generation circuit that generates a trigger signal at the predetermined timing, and
an error signal generation circuit that outputs the second error signal in response to the trigger signal, and
wherein the trigger generation circuit includes
a program-counter monitor circuit that outputs a program-counter coincidence signal in a case where a value of a program counter of the processor circuit and a predetermined program-counter setting value are coincident with each other, and
a timer circuit that starts a timer operation in response to a timer start-up signal and outputs a timer coincidence signal when reaching a predetermined timer setting value.

12. The semiconductor device according to claim 11,
wherein the error injection circuit includes
a program-counter setting register that determines the program-counter setting value,
a timer setting register that determines the timer setting value, and
a data setting register that determines the second error signal.

13. The semiconductor device according to claim 12,
wherein the program-counter setting register, the timer setting register, and the data setting register are coupled by a scan chain, and
the semiconductor device includes an external terminal for JTAG (Joint Test Action Group) that accesses the scan chain.

14. The semiconductor device according to claim 12,
wherein the error injection circuit is coupled to the processor circuit via the bus, and
wherein the memory circuit has
test initial data, and
a test initialization program for causing the processor circuit to write the test initial data to the program-counter setting register, the timer setting register, and the data setting register.
